(19) United States
(12) Patent Application Publication
(10) Pub. No.: US 2026/0135631 A1
(43) Pub. Date: May 14, 2026

(54) ELECTRONIC DEVICE AND METHOD APPLIED TO ELECTRONIC DEVICE SUPPORTING NARROWBAND INTERNET OF THINGS

(71) Applicant: Realtek Semiconductor Corp., HsinChu (TW)

(72) Inventors: Fengxiang Wang, Suzhou City (CN); YingQun Xu, Suzhou City (CN); Jyun-Wei Pu, HsinChu (TW)

(73) Assignee: Realtek Semiconductor Corp., HsinChu (TW)

(21) Appl. No.: 19/377,057

(22) Filed: Nov. 3, 2025

(30) Foreign Application Priority Data
Nov. 14, 2024 (CN) 202411633875.5

(51) Int. Cl. H04B 17/373

(52) U.S. Cl. CPC H04B 17/373

(57) ABSTRACT

The present invention provides a method applied to an electronic device supporting NB-IoT, The method comprises steps of: selecting a cost function; simulating a first PDF of the cost function at a target center frequency, a second PDF of the cost function at a first adjacent center frequency of the target center frequency, a third PDF of the cost function at a second adjacent center frequency of the target center frequency, and a fourth PDF of the cost function at a pure noise center frequency, wherein the target center frequency is a center frequency of a frame transmitted by a base station; and calculating a probability that the electronic device successfully detects the target center frequency of the frame from the base station through a frequency scanning, according to the first PDF, the second PDF, the third PDF and the fourth PDF.

### BACKGROUND OF THE INVENTION

### 1. Field of the Invention

The present invention relates to a wireless communication system.

### 2. Description of the Prior Art

At the early stage of product design, simulation and evaluation are commonly used to predict product performance, serving as a reference for subsequent product realization. However, for certain products, the workload involved in simulation and evaluation can be extremely high, causing challenges for designers. Taking Narrowband Internet of Things (NB-IoT) as an example, its system requires scanning thousands of center frequencies during frequency scanning operations, making the simulation and evaluation process highly time-consuming. Therefore, developing an efficient simulation and evaluation method is an important topic.

### SUMMARY OF THE INVENTION

Therefore, one of the objectives of the present invention is to propose a method applied to an electronic device supporting NB-IoT, which can efficiently predict system performance when scanning multiple center frequencies, thereby addressing the issues mentioned in the prior art.

According to one embodiment of the present invention, a method applied to an electronic device supporting NB-IoT comprises steps of: selecting a cost function; simulating a first probability density function (PDF) of the cost function at a target center frequency, a second PDF of the cost function at a first adjacent center frequency of the target center frequency, a third PDF of the cost function at a second adjacent center frequency of the target center frequency, and a fourth PDF of the cost function at a pure noise center frequency, wherein the target center frequency is a center frequency of a frame transmitted by a base station; and calculating a probability that the electronic device successfully detects the target center frequency of the frame from the base station through a frequency scanning, according to the first PDF, the second PDF, the third PDF and the fourth PDF.

According to one embodiment of the present invention, an electronic device is configured to perform steps of: selecting a cost function; simulating a first probability density function (PDF) of the cost function at a target center frequency, a second PDF of the cost function at a first adjacent center frequency of the target center frequency, a third PDF of the cost function at a second adjacent center frequency of the target center frequency, and a fourth PDF of the cost function at a pure noise center frequency, wherein the target center frequency is a center frequency of a frame transmitted by a base station; and calculating a probability that the electronic device successfully detects the target center frequency of the frame from the base station through a frequency scanning, according to the first PDF, the second PDF, the third PDF and the fourth PDF.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to one embodiment of the present invention.

FIG. 2 is a flowchart of a method for determining the probability that the electronic device successfully detects a target center frequency of a frame from a base station, according to one embodiment of the present invention.

### DETAILED DESCRIPTION

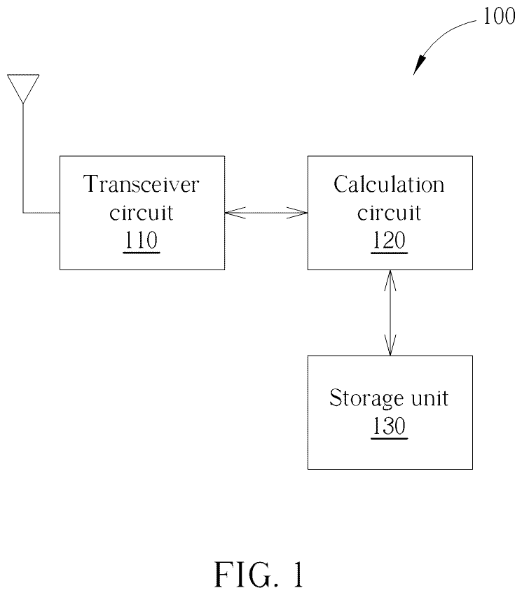

FIG. 1 is a schematic diagram of an electronic device 100 according to one embodiment of the present invention, where the electronic device 100 is a user terminal device supporting NB-IoT. As shown in FIG. 1, the electronic device 100 includes a transceiver circuit 110, a calculation circuit 120, and a storage unit 130. In the operation of the electronic device 100, the transceiver circuit 110 comprises a wireless communication function used for wireless communication with a base station (the based station can also be named as a cell). The calculation circuit 120 can be a circuit or electronic component with program execution capability, such as a central processing unit (CPU), microprocessor, or micro-processing unit, which performs the functions of the electronic device 100 by executing program codes or program instructions stored in the storage unit 130.

During the process of establishing a connection between the electronic device 100 and the base station, the calculation circuit 120 receives at least one frame (signal frame) from the base station via the transceiver circuit 110. Then, the calculation circuit 120 synchronizes with the base station based on a Narrowband Primary Synchronization Signal (NPSS) and a Narrowband Secondary Synchronization Signal (NSSS) included in the frame. The details of the synchronization process between the electronic device 100 and the base station are well known to those skilled in the art, for example, reference can be made to U.S. Pat. No. 10,455,485. Therefore, the relevant details are not described here.

Furthermore, during the process of establishing a connection with the base station, the electronic device 100 first performs frequency scanning to determine a target center frequency of the frame transmitted by the base station before proceeding with subsequent operations. For example, without limiting the present invention, the frame transmitted by the base station may include 12 subcarriers with a subcarrier spacing of 15 kilo-Hertz (kHz) and a signal bandwidth of 180 kHz. The interval between two adjacent center frequencies is 100 kHz, and the electronic device 100 needs to perform 1,950 center frequency scans to determine the target center frequency of the frame transmitted by the base station. Additionally, the electronic device 100 employs a cost function. During the frequency scanning process, the calculation circuit 120 uses this cost function to obtain a calculation result for each center frequency. The cost function is designed based on the characteristics of the NPSS in the frame, and its calculation result reflects the energy of the scanned center frequency. As a result, when scanning the target center frequency, the calculation result will show a significant difference compared to scanning non-target center frequencies. For instance, the calculation result for the target center frequency typically has a higher value. Therefore, the calculation circuit 120 can determine the target center frequency of the frame transmitted by the base station based on the calculation results corresponding to each center frequency. In addition, since the above-mentioned frequency scanning operation and the design and operation of the cost function are well known to those skilled in the art, reference can be made to U.S. Pat. No. 10,455,485 and the “NB-PSS and NB-SSS Design” proposed by Qualcomm Incorporated at 2016, 3rd Generation Partnership Project (3GPP) meeting. Therefore, the relevant details are not described here.

However, although in theory, the calculation result obtained when scanning the target center frequency should significantly differ from that obtained when scanning non-target center frequencies, various non-ideal factors may affect this outcome. For example, the calculation result at the target center frequency may not always have the highest value, as scanning the target center frequency is a probabilistic event. Therefore, the present invention proposes the following embodiments to efficiently predict the performance of the electronic device 100 after scanning multiple center frequencies. Specifically, it aims to predict the probability that the electronic device 100 can distinguish the target center frequency based on the calculation results corresponding to each center frequency. This prediction serves as a basis for designing the operational behavior of the electronic device 100.

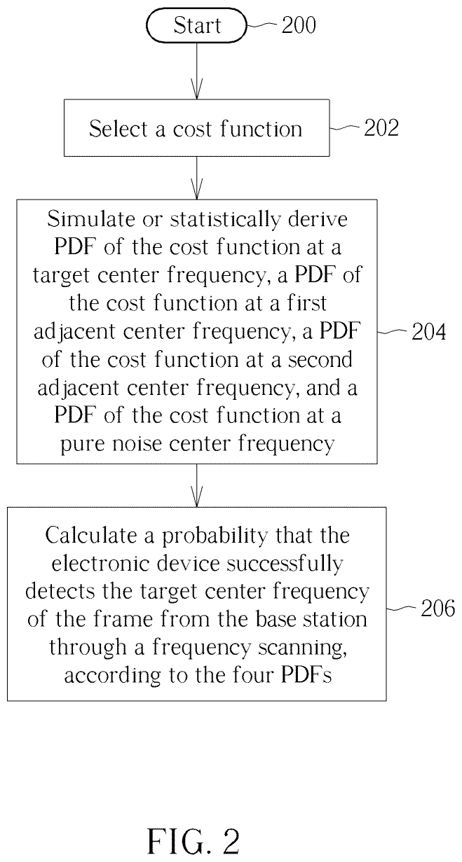

FIG. 2 is a flowchart of a method for determining the probability that the electronic device 100 successfully detects the target center frequency of a frame from a base station, according to one embodiment of the present invention. The flow described in FIG. 2 can be executed either by the electronic device 100 itself or by another electronic device. In Step 200, the flow starts. In Step 202, a cost function is selected, such as the one proposed in “NB-PSS and NB-SSS Design” of Qualcomm Incorporated. In Step 204, simulate or statistically derive the following information: (1) a probability density function (PDF) of the cost function corresponding to the target center frequency of the frame transmitted by the base station; (2) a PDF of the cost function corresponding to a first adjacent center frequency (e.g., the center frequency corresponding to 100 kHz below the target center frequency); (3) a PDF of the cost function corresponding to a second adjacent center frequency (e.g., the center frequency corresponding to 100 kHz above the target center frequency); (4) a PDF of the cost function corresponding to a pure noise center frequency, which is located at a sufficient distance from the target center frequency (e.g., 500 kHz or more) to ensure that signals from the target center frequency do not interfere with it, making it represent pure noise. In one embodiment, the PDFs are generated through multiple simulations or statistical analyses (e.g., 5000 iterations) of the cost function distributions at the target center frequency, first adjacent center frequency, second adjacent center frequency, and pure noise center frequency. Some values within the PDFs can be smoothed using interpolation operations. Additionally, in one embodiment, the PDF describes the probability distribution of the cost function values within a specific frequency range.

In Step 206, based on the four PDFs determined in Step 204, the probability that the electronic device 100 successfully detects the target center frequency of the frame from the base station through frequency scanning is calculated. In this embodiment, the calculation is determined according to the frequency scanning strategy used by the electronic device 100 when applying the cost function for scanning. The scanning strategy can be either a time-division scanning strategy or a non-time-division scanning strategy, which influences how the four PDFs are utilized to calculate the probability of successful detection.

If the electronic device 100 adopts a time-division scanning strategy, it can perform multiple rounds of scanning (e.g., three rounds), where each round scans only a subset of the total center frequencies and uses the cost function to obtain calculation results for each scanned center frequency. After completing all three rounds, the probability of successfully determining the target center frequency is then calculated. Specifically, assuming that the electronic device 100 needs to scan a total of 1,950 center frequencies, with a 100 kHz spacing between adjacent center frequencies, and that it conducts three rounds of scanning, each round will scan 650 center frequencies, with a 300 kHz spacing between the center frequencies scanned in each round. For example, assuming that lower-indexed center frequencies correspond to lower frequencies: in the first round, the electronic device scans center frequencies 2, 5, 8, 11, . . . , 1949; in the second round, it scans center frequencies 1, 4, 7, 10, . . . , 1948; and in the third round, it scans center frequencies 3, 6, 9, 12, . . . , 1950. For predicting the probability of detecting the target center frequency, let: the PDF of the target center frequency be f₀(x), the PDF of the first adjacent center frequency (e.g., 100 kHz below the target center frequency) be f₋₁(x), the PDF of the second adjacent center frequency (e.g., 100 kHz above the target center frequency) be f₊₁(x), and the PDF of a pure noise center frequency be fₙ(x). During the first round of scanning, the probability P₀ that the calculation result of the cost function at the target center frequency is greater than calculation results of all other center frequencies can be calculated using the following Equation (1):

$${P}_{0} = {\int }_{0}^{+ ∞} {{f}_{0} ( x ) [ {\int }_{0}^{x} {f}_{n} ( y ) d y ]}^{N - 1} d x = {\int }_{0}^{+ ∞} {{f}_{0} ( x ) [ {F}_{n} ( x ) ]}^{N - 1} dx . \qquad ( 1 )$$

During the second round of scanning, the probability P₋₁ that the calculation result of the cost function at the first adjacent center frequency (i.e., the center frequency 100 kHz below the target center frequency) is greater than calculation results at all other center frequencies can be calculated using the following Equation (2):

$${P}_{- 1} = {\int }_{0}^{+ ∞} {{f}_{- 1} ( x ) [ {\int }_{0}^{x} {f}_{n} ( y ) d y ]}^{N - 1} d x = {\int }_{0}^{+ ∞} {{f}_{- 1} ( x ) [ {F}_{n} ( x ) ]}^{N - 1} d x . \qquad ( 2 )$$

During the third round of scanning, the probability P₊₁ that the calculation result of the cost function at the second adjacent center frequency (i.e., the center frequency 100 kHz above the target center frequency) is greater than the calculation results at all other center frequencies can be calculated using the following Equation (3):

$${P}_{+ 1} = {\int }_{0}^{+ ∞} {{f}_{+ 1} ( x ) [ {\int }_{0}^{x} {f}_{n} ( y ) d y ]}^{N - 1} d x = {\int }_{0}^{+ ∞} {{f}_{+ 1} ( x ) [ {F}_{n} ( x ) ]}^{N - 1} d x . \qquad ( 3 )$$

N represents the number of center frequencies scanned in each round, and in this embodiment, N=650. In this embodiment, since the signal bandwidth is 180 kHz and the interval between adjacent center frequencies is 100 kHz, the frame transmitted by the base station may appear within a range of up to three center frequencies. This means that if the frame corresponds to the target center frequency, there is a possibility that the first adjacent center frequency and/or the second adjacent center frequency may also detect the frame. Therefore, as long as the target center frequency, the first adjacent center frequency, or the second adjacent center frequency is detected by the electronic device 100 as having a signal present, the frequency scanning process can be considered successful. Thus, across the three rounds of scanning, the probability P that the electronic device 100 successfully detects the target center frequency of the frame from the base station can be calculated using Equation (4), based on the probabilities P₀, P₋₁, and P₊₁ determined from Equations (1), (2), and (3), respectively:

$$P = 1 - ( 1 - {P}_{0} ) ( 1 - {P}_{- 1} ) ( 1 - {P}_{+ 1} ) . \qquad ( 4 )$$

If the electronic device 100 does not adopt a time-division scanning strategy, it will perform only one round of scanning, meaning it will scan all 1,950 center frequencies in a single round. In this case, since strength of the signal (e.g., the NPSS) at the target center frequency, the first adjacent center frequency, and the second adjacent center frequency are correlated to some extent, the cost function values at these frequencies are not entirely independent. Thus, the probability P of successfully detecting the signal can be calculated using Equations (5) to (8):

$$\begin{matrix}{P}_{0 - Full} = {\int }_{0}^{+ ∞} f ( {x}_{{T}_{0}} \vert {x}_{{T}_{0}} \\ {= max ( {x}_{{T}_{0}} , {x}_{{T}_{- 1}} , {x}_{{T}_{+ 1}} ) ) [ {\int }_{0}^{{x}_{{T}_{0}}} {f}_{n} ( y ) dy ]}^{3 N - 3} {dx}_{{T}_{0}} \\ = {\int }_{0}^{+ ∞} f ( {x}_{{T}_{0}} \vert {x}_{{T}_{0}} \\ {= max ( {x}_{{T}_{0}} , {x}_{{T}_{- 1}} , {x}_{{T}_{+ 1}} ) ) [ {F}_{n} ( {x}_{{T}_{0}} ) ]}^{3 N - 3} {dx}_{{T}_{0}}\end{matrix} \qquad ( 5 )$$

$$\begin{matrix}{P}_{+ 1 - Full} = {\int }_{0}^{+ ∞} f ( {x}_{{T}_{+ 1}} \vert {x}_{{T}_{+ 1}} \\ {= max ( {x}_{{T}_{0}} , {x}_{{T}_{- 1}} , {x}_{{T}_{+ 1}} ) ) [ {F}_{n} ( {x}_{{T}_{+ 1}} ) ]}^{3 N - 3} d {x}_{{T}_{+ 1}} ;\end{matrix} \qquad ( 6 )$$

$$\begin{matrix}{P}_{- 1 - Full} = {\int }_{0}^{+ ∞} f ( {x}_{{T}_{- 1}} \vert {x}_{{T}_{- 1}} \\ {= max ( {x}_{{T}_{0}} , {x}_{{T}_{- 1}} , {x}_{{T}_{+ 1}} ) ) [ {F}_{n} ( {x}_{{T}_{- 1}} ) ]}^{3 N - 3} {dx}_{{T}_{- 1}} ;\end{matrix} \qquad ( 7 )$$

$${P}_{de t} = 1 - ( 1 - {P}_{0 - Full} ) ( 1 - {P}_{+ 1 - Full} ) ( 1 - {P}_{- 1 - Full} ) . \qquad ( 8 )$$

x_{T0}, x_{T-1}, and x_{T+1} represent the variations in the cost function at the target center frequency, the first adjacent center frequency, and the second adjacent center frequency, respectively.

In the above embodiments, by determining only the PDFs of the cost function at the target center frequency, the first adjacent center frequency, the second adjacent center frequency, and the pure noise center frequency, it can accurately estimate the probability that the electronic device 100 can successfully perform frequency scanning. That is, if the calculation result of the cost function at any one of the target center frequency, the first adjacent center frequency, or the second adjacent center frequency is greater than the calculation results at all other center frequencies, the scanning process is considered successful. This method effectively eliminates the need to calculate the cost function for all 1,950 center frequencies, thereby significantly reducing the time-consuming workload required for simulation and evaluation in prior art.

After simulating (or evaluating) the probability that the electronic device 100 can successfully perform frequency scanning, the scanning strategy of the electronic device 100 can be adjusted based on the calculated probability of successfully detecting the target center frequency of the frame from the base station. For example, the designer can use this information to determine whether to select a different cost function or adopt an alternative scanning strategy. For instance, if the simulated or evaluated probability of successful scanning is below a threshold value, the electronic device 100 can first identify the top M center frequencies with the highest cost function values, and then re-scans these M center frequencies in a focused manner and selects the one with the highest cost function value as the target center frequency. Here, M is a positive integer greater than or equal to 2.

Furthermore, in Equation (1) above, the probability is calculated for the case where the calculation result of the cost function at the target center frequency is greater than that at all other center frequencies. In other embodiments, the probability can be calculated using the following Equation (9), which determines the probability that the calculation result of the cost function at the target center frequency is greater than that of (N−M) other center frequencies (i.e., the target center frequency ranks within the top M positions):

$${P}_{0 \_ T {op}_{M}} = {\int }_{0}^{+ ∞} {f}_{0} ( x ) \{ {\sum }_{i = 0}^{M - 1} {{{C}_{N - 1}^{i} [ 1 - F ( x ) ]}^{i} [ F ( x ) ]}^{N - 1 - i} \} dx . \qquad ( 9 )$$

As for the probability that the calculation result of the cost function at the first adjacent center frequency is greater than that of (N−M) other center frequencies, and the probability that the calculation result of the cost function at the second adjacent center frequency is greater than that of (N−M) other center frequencies, these probabilities can be derived by modifying Equation (9) accordingly.

It should be noted that in the above embodiments, the explanation is based on the assumption that the electronic device 100 needs to scan 1,950 center frequencies, with a 100 kHz frequency interval between adjacent center frequencies. However, these specific values are not limitations of the present invention. In other embodiments, as long as the number of center frequencies that the electronic device 100 needs to scan is 3*N, the first, second, and third rounds of scanning each scans N center frequencies, the center frequencies scanned in the first, second, and third rounds do not overlap, the frequency interval between adjacent center frequencies is A, the frequency interval between adjacent center frequencies scanned within the same round is 3*A, the described design variations should be considered within the scope of the present invention. Here, N can be any suitable positive integer. For example, if N=650 and A=100 kHz.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method applied to an electronic device supporting Narrowband Internet of Things (NB-IoT), comprising:
selecting a cost function;
simulating a first probability density function (PDF) of the cost function at a target center frequency, a second PDF of the cost function at a first adjacent center frequency of the target center frequency, a third PDF of the cost function at a second adjacent center frequency of the target center frequency, and a fourth PDF of the cost function at a pure noise center frequency, wherein the target center frequency is a center frequency of a frame transmitted by a base station; and
calculating a probability that the electronic device successfully detects the target center frequency of the frame from the base station through a frequency scanning, according to the first PDF, the second PDF, the third PDF and the fourth PDF.

2. The method of claim 1, wherein the step of calculating the probability that the electronic device successfully detects the target center frequency of the frame from the base station through the frequency scanning, based on the first PDF, the second PDF, the third PDF and the fourth PDF comprises:
calculating a first probability that a calculation result of the cost function at the target center frequency is greater than calculation results at other center frequencies in a first round of scanning performed by the electronic device, according to the first PDF and the fourth PDF;
calculating a second probability that a calculation result of the cost function at the first adjacent center frequency is greater than calculation results at other center frequencies in a second round of scanning performed by the electronic device, according to the second PDF and the fourth PDF;
calculating a third probability that a calculation result of the cost function at the second adjacent center frequency is greater than calculation results at other center frequencies in a third round of scanning performed by the electronic device, according to the third PDF and the fourth PDF; and
using the first probability, the second probability and the third probability to calculate the probability that the electronic device successfully detects the target center frequency of the frame from the base station.

3. The method of claim 2, wherein a number of center frequencies that the electronic device needs to scan is 3*N, a number of center frequencies scanned in each of the first round, the second round and the third round is N, the center frequencies scanned in the first round, the second round and the third round do not overlap, a frequency interval between two adjacent center frequencies is A, and a frequency interval between two adjacent center frequencies scanned within each of the first round, the second round and the third round is 3*A.

4. The method of claim 3, wherein N is equal to 650, and A is equal to 100 kHz.

5. The method of claim 1, further comprising:
determining a target frequency scanning method of the electronic device according to the probability that the electronic device successfully detects the target center frequency of the frame from the base station.

6. An electronic device, configured to perform steps of:
selecting a cost function;
simulating a first probability density function (PDF) of the cost function at a target center frequency, a second PDF of the cost function at a first adjacent center frequency of the target center frequency, a third PDF of the cost function at a second adjacent center frequency of the target center frequency, and a fourth PDF of the cost function at a pure noise center frequency, wherein the target center frequency is a center frequency of a frame transmitted by a base station; and
calculating a probability that the electronic device successfully detects the target center frequency of the frame from the base station through a frequency scanning, according to the first PDF, the second PDF, the third PDF and the fourth PDF.

7. The electronic device of claim 6, wherein the step of calculating the probability that the electronic device successfully detects the target center frequency of the frame from the base station through the frequency scanning, based on the first PDF, the second PDF, the third PDF and the fourth PDF comprises:
calculating a first probability that a calculation result of the cost function at the target center frequency is greater than calculation results at other center frequencies in a first round of scanning performed by the electronic device, according to the first PDF and the fourth PDF;
calculating a second probability that a calculation result of the cost function at the first adjacent center frequency is greater than calculation results at other center frequencies in a second round of scanning performed by the electronic device, according to the second PDF and the fourth PDF;
calculating a third probability that a calculation result of the cost function at the second adjacent center frequency is greater than calculation results at other center frequencies in a third round of scanning performed by the electronic device, according to the third PDF and the fourth PDF; and
using the first probability, the second probability and the third probability to calculate the probability that the electronic device successfully detects the target center frequency of the frame from the base station.

8. The electronic device of claim 7, wherein a number of center frequencies that the electronic device needs to scan is 3*N, a number of center frequencies scanned in each of the first round, the second round and the third round is N, the center frequencies scanned in the first round, the second round and the third round do not overlap, a frequency interval between two adjacent center frequencies is A, and a frequency interval between two adjacent center frequencies scanned within each of the first round, the second round and the third round is 3*A.

9. The electronic device of claim 8, wherein N is equal to 650, and A is equal to 100 kHz.

10. The electronic device of claim 6, further comprising:
determining a target frequency scanning method of the electronic device according to the probability that the electronic device successfully detects the target center frequency of the frame from the base station.
